(19) United States
(12) Patent Application Publication
(10) Pub. No.: US 2011/0190568 A1
(43) Pub. Date: Aug. 4, 2011

(54) ENHANCED PERFORMANCE IMPLANTABLE MICROPHONE SYSTEM

(76) Inventor: Koen Van Den Heuvel, Hove (BE)

(21) Appl. No.: 13/001,556

(22) PCT Filed: Jun. 25, 2009
(86) PCT No.: PCT/AU2009/000811

§ 371 Date: Apr. 22, 2011

(30) Foreign Application Priority Data
Jun. 25, 2008 (AU) 2008903255

(51) Int. Cl. H04R 25/00

(52) U.S. Cl. 600/25

(57) ABSTRACT

To improve the performance of an implantable hearing prothesis having an implanted microphone, the present invention discloses the use of an acoustic hearing aid to amplify the ambient sound signals. This results in a higher signal level for the implanted microphone, and hence improved performance.

### CROSS-REFERENCE TO RELATED APPLICATION

The present application is a National Stage application of International Patent Application No. PCT/AU2009/000811, filed Jun. 25, 2009, and claims priority from Australian Patent Application No. 2008903255, filed Jun. 25, 2008. The content of these applications is hereby incorporated by reference herein.

### BACKGROUND

1. Field of the Invention

The present invention relates to generally to hearing prostheses and more particularly to hearing prostheses including an implantable microphone.

2. Related Art

Hearing prostheses of various types are widely used to improve the lives of users. Such devices include, for example, hearing aids, cochlear implants, middle ear implants and electro-acoustic devices. A current trend is to develop totally implantable forms of these devices. Totally implantable devices have the advantage of allowing the user to have a superior aesthetic result, as the user is visually indistinguishable in day to day activities. They have a further advantage in generally being inherently waterproof, allowing the user to shower, swim, and so forth without needing to take any special measures.

Totally implantable devices, relative to partially implantable devices, typically have two particular requirements. Such devices require at least a degree of electrical storage or other independent power supply to be provided internally. Totally implanted devices having an implanted battery arrangement require periodic recharging, typically using a transcutaneous RP inductive power arrangement.

Another issue relates to the provision of a suitable implantable microphone. Conventional hearing prostheses, for example partially implanted cochlear implant systems, use externally disposed microphones. Replacing the external microphone assembly with a subcutaneous microphone assembly presents various practical difficulties. The microphone assembly may need to be hermetically sealed. The thickness of the skin or tissue overlying the microphone acts to attenuate the air-carried sound signals, through directly attenuating the signal. A further loss of signal occurs through impedance matching effects associated with the sound signal passing from air into the body. The implanted microphone is also subject to substantial noise from internal body noises.

U.S. Pat. Nos. 6,067,474 to Schulman and 6,556,870 to Ziefhofer disclose arrangements in which an external microphone is used to transmit acoustic signals via a wireless link to the implanted device. They therefore avoid the requirements for an implanted microphone.

### SUMMARY

In one aspect of the invention, there is provided a hearing prosthesis system, comprising: an implantable device including an implantable microphone and a stimulation device, and an externally disposed acoustic hearing aid, wherein said system is operatively arranged so that the acoustic hearing aid amplifies the received sound signal, so as to provide an amplified sound signal for the implanted microphone.

In accordance with another aspect of the present invention, there is provided a method of improving the performance of an implanted microphone, comprising: positioning an acoustic hearing aid so that is externally disposed of a recipient; receiving sound, by the acoustic hearing aid; amplifying, by the acoustic hearing aid, the sound to provide an amplified sound signal; receiving the amplified sound signal by the implanted microphone.

### BRIEF DESCRIPTION OF THE DRAWINGS

Illustrative embodiments of the present invention will now be described with reference to the accompanying figures, in which:

FIG. 1 is a view illustrating a prior art totally implanted communication assistance (TICA) system; and

FIG. 2 is a similar view, illustrating one implementation of the present invention.

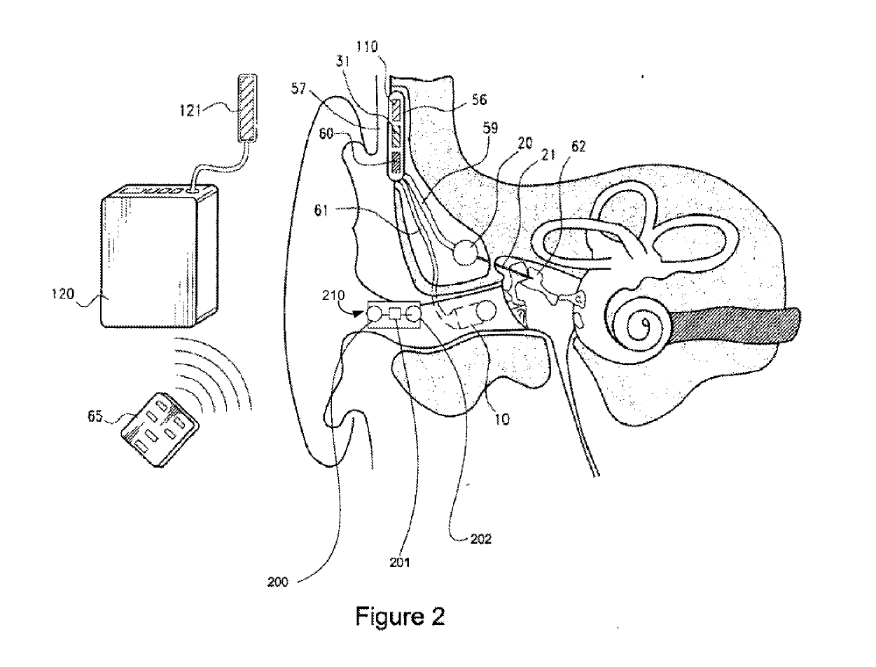

### DETAILED DESCRIPTION

An embodiments of the present invention will be described with reference to a particular illustrative example, which is a system intended for use with a totally implantable communication assistance (TICA) system. However, it will be appreciated that the present invention is applicable wherever an implantable microphone is used. It may be applied to a cochlear implant system such as a hybrid electrical/acoustic system, an implantable hearing aid system, a middle ear stimulator, or any other suitable hearing prosthesis. It may be applied to a system with only some implanted components, or to a fully implanted system. It will be appreciated that the present implementation is described for illustrative purposes, and its features are not intended to be limitative of the scope of the present invention. Many variations and additions are possible within the scope of the present invention.

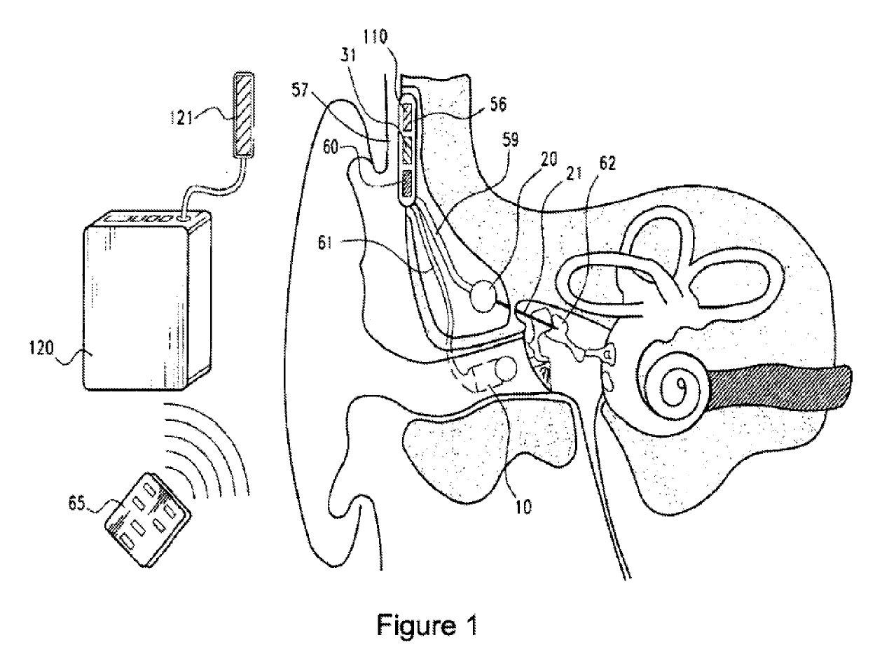

The illustrated prior art TICA system, shown in FIG. 1, is intended to be generally illustrative of an exemplary system in which an embodiment of the present invention may be implemented. In general terms, illustrated is an implanted middle ear stimulator system, including an electromechanical converter 20, an implanted processor 56, and microphone 10. The operation of the stimulation system, sound processing, and so forth may be of any suitable type, including any of the commercially available devices, and so will not be described in detail. Indeed, the present invention can be applied with any type of implanted microphone.

In this arrangement, the implanted microphone 10 is located under the skin of the outer ear canal wall. Since the microphone sits under a thin layer of skin, the sound is attenuated, typically by about 10 dB. Due to this attenuation, the dynamic range of the signal received by the implanted microphone is lower when compared to an external microphone operating in air. As the signal has a reduced dynamic range, consequently the quality of the input signal to subsequent processing is reduced, and hence the likelihood is that speech perception by the user will also be reduced in quality.

According to an embodiment of the present invention, the user also wears an in-the-ear hearing aid 210. Hearing aid 210 amplifies the sound, for example by an extra 10 dB, so as to raise the signal level available for detection by the implanted microphone 10, in order to offset the attenuation caused by the skin. In hearing aid 210, the sound is picked up first by the external microphone 200, amplified by amplifier 201, and then output via speaker 202. The output is into the ear canal, so that the amplified sound is picked up by the implanted microphone 10.

The hearing aid may be of any conventional type, appropriate to the level of amplification required. It is preferred for cosmetic reasons that it be an ITE (in the ear) device. However, embodiments of the present invention could be implemented with any type of external acoustic amplification arrangement. Whilst the term external hearing aid is used, this is intended to encompass devices partly or fully extending into the ear canal. It is intended to distinguish devices which are accessible from the outside of the user's body from those which are implanted within the body.

It will be appreciated that this implementation will still be operable without the external hearing aid. The user can enjoy the full advantages of a totally implanted system, which will still be functional at a reduced level of signal quality without the external device. This is in contrast to systems using a wireless external microphone. The user could opt to have the external device in use or not, depending upon the situation, perhaps analogous to the use of reading glasses.

The location of the implanted microphone and the external hearing aid speaker needs to be considered in conjunction. Other locations apart from the inner ear canal wall are possible. The advantages of improved signal level will be most apparent when the speaker and microphone are in close proximity. A mechanism to assist retaining such proximity, for example a magnet associated with both the microphone and speaker to keep them in the correct relative positions, may be used.

Another implementation may use an implanted microphone which is located in the middle ear, for example as disclosed in U.S. Patent Application Ser. No. 61/061250, from which International Patent Publication No. WO2009/152528 claims priority.

An additional benefit of operating a system using a commercially available hearing aid is that the benefit of various features of such devices can be readily obtained, for example connectivity to accessories, FM systems, telecoils, and pre-processing options like beam-formers and noise reducers. For example, the external microphone may provide an interface to a wireless MP3 or other music reproduction device, a radio, or a telephone interface.

It is emphasized that the present invention may be used whenever an implantable microphone is used. It may be used with a fully implantable cochlear implant (e.g. as shown in U.S. Pat. Nos. 6,067,474, and 6,358,281; and US Patent Publication No. 2003/0171787); a middle ear implant (e.g., as shown in U.S. Pat. No. 6,475,134 and International Patent Publication No. WO 2006/058368); an inner ear implant; a bone conducting implant (e.g. WO0193635A1); or an electro-acoustic system, combining electrical, acoustic and/or mechanical stimulation. The implantable microphone used may be of any suitable type. It may be subcutaneous (e.g. as shown in U.S. Pat. No. 6,626,822); close to the ear canal (e.g. as shown in U.S. Pat. Nos. 5,814,095 and 6,394,947); in the middle ear (for example as shown in U.S. Pat. Nos. 6,005,955, 6,216,040, 6,473,651, 6,636,768, 6,491,644, 5,906,635, 5,997,466); in the inner ear (e.g. as shown in U.S. Patent Publication No. 2005/0177204); and combinations of the above (for example U.S. Pat. No. 6,807,445).

The hearing aid used may be a behind the ear (BTE) type, in the ear (ITE), in the canal (ITC), bone conduction device, a device with a receiver in the ear or combinations of the above.

For users with residual hearing, the present invention may be used as part of an electroacoustic system. The acoustic stimulation, via the normal pathway (tympanic membrane, middle ear structures, inner ear) can be used for the acoustic component, whilst an implanted microphone can receive the amplified acoustic signal for use in a totally implanted cochlear stimulation device.

Since not much amplification is generally needed to overcome the attenuation of the implanted microphone, a hearing aid of the type which is intended to aid people with a mild hearing loss can be used. Typically, these hearing aids are very small devices with a long battery life. Further, hearing prostheses typically include an automatic gain control (AGC) in the implant will make sure that the sound is at the right level for the patient both when the external hearing aid is used, and when it is not.

The disclosures of the referenced patents and other documents are hereby incorporated by reference.

1. A hearing prosthesis system, comprising:
an implantable device including an implantable microphone and a stimulation device, and
an externally disposed acoustic hearing aid, wherein said system is operatively arranged so that the acoustic hearing aid amplifies the received sound signal, so as to provide an amplified sound signal for she implanted microphone.

2. A hearing prosthesis system according to claim 1, wherein the acoustic hearing aid is configured to operatively provide an output proximate to the implanted microphone.

3. A hearing prosthesis according to claim 1, wherein the prosthesis is operable without the acoustic hearing aid.

4. A. hearing prosthesis system according to claim 1, wherein the acoustic hearing aid is adapted to be at least partially disposed in the ear canal.

5. A hearing prosthesis according to claim 2, further comprising:
a retention mechanism configured to maintain a desired relationship between the implantable microphone and a speaker from the acoustic hearing aid.

6. A hearing prosthesis system according to claim 1, wherein the implantable device is a cochlear implant, combined electrical and acoustic stimulator, a neural stimulation device, a middle ear implant, a mechanical stimulator or an implanted hearing aid.

7. A method of improving the performance of an implanted microphone, comprising:
positioning an acoustic hearing aid so that is externally disposed of a recipient;
receiving sound, by the acoustic hearing aid;
amplifying, by the acoustic hearing aid, the sound to provide an amplified sound signal;
receiving the amplified sound signal by the implanted microphone.

8. A method according to claim 7, wherein positioning the acoustic hearing aid comprises:
positioning the hearing aid so that the amplified sound signal is output proximate to the implanted microphone.

9. A method according to claim 7, wherein positioning the acoustic hearing aid comprises:
positioning the acoustic hearing aid so that it is at least partially disposed in the ear canal.
